(19) United States
(12) Patent Application Publication
(10) Pub. No.: US 2021/0235917 A1
(43) Pub. Date: Aug. 5, 2021

(54) BEVERAGE PREPARATION DEVICES, APPARATUS AND METHODS

(71) Applicant: Koninklijke Douwe Egberts B.V., Utrecht (NL)

(72) Inventors: Pieter Jacobus Veenendaal, Utrecht (NL); Johannes Cornelis Nieuwlaat, Utrecht (NL)

(21) Appl. No.: 17/052,515

(22) PCT Filed: May 2, 2019
(86) PCT No.: PCT/EP2019/061270

§ 371 Date: Nov. 2, 2020

(30) Foreign Application Priority Data
May 8, 2018 (GB) 1807484.9

(51) Int. Cl. A47J 31/057; A47J 31/08; A23F 5/26

(52) U.S. Cl. CPC A47J 31/057; A23F 5/26; A47J 31/08

(57) ABSTRACT

A beverage extraction device comprising an upper chamber and a lower chamber separated by a filter; wherein the upper chamber comprises a perimeter wall and an inlet and the lower chamber comprises a perimeter wall and an outlet; and wherein the perimeter wall of the upper chamber adjacent to the filter tapers inwardly, towards the filter, by no more than 10 degrees and the perimeter wall of the lower chamber tapers inwardly from adjacent to or proximal to the filter.

### TECHNICAL FIELD OF THE INVENTION

The present invention relates to devices and apparatus for the extraction of coffee to produce beverages, particularly to devices and apparatus that operate under atmospheric pressure. The invention further relates to devices and apparatus that may be used in conjunction with traditional filter coffee machines.

### BACKGROUND TO THE INVENTION

‘Drip filtering’ is a known method of extracting a beverage liquid from a bed or dispersion of coffee. The known process relies on a beverage extraction device comprising a generally funnel shaped filter device, having a conical or frusto-conical chamber leading to an aperture or a tubular parallel-walled outlet. A conical or frusto-conical filter paper lines the chamber, which forms a screen between the chamber and the funnel outlet for coffee extract. To use such a device the process consists generally of loading ground coffee into the chamber, onto the filter, to form a coffee bed and then pouring water over and through the coffee bed such that coffee extract is delivered through the filter and out of the funnel outlet, leaving the coffee bed behind. In general, there is also a container below the filter, such as a cup or jug, and there may or may not be a further conduit between filter and container in order to gather and channel the extract as it comes from the filter.

Water is driven through the known drip filter beverage extraction devices under gravity. The flow rate of water through known drip filter devices is further limited and impaired by the resistance of the coffee bed and filter paper and such resistance is enhanced during use as the particulate coffee is carried onto the filter paper by the flow of water clogging the pores of the filter paper, such that water flow rate through a known drip filter is slowed dramatically as water flows through the beverage extraction device.

The coffee bed and water contact time is known to be important for extent of coffee extraction. A coffee bed and water contact time that is too long results in an over-extracted, bitter beverage. Conversely a coffee bed and water contact time that is too short results in a beverage that is less flavoursome.

Drip filter beverage extraction devices of the prior art rely on a steady and consistent addition of water to the upper chamber in order to optimise the extraction of the coffee. Machines are known that go some way to providing a solution, including “filter coffee machines”, such as the Styline® TKA8011, manufactured by Bosch, and are well known in the art. These coffee filter machines act in much the same way as manual drip filter devices with the additional advantages of controlled temperature and flow of water into the extraction device and coffee bed and, usually, a heated plate to store the container of extracted beverage underneath the extraction device.

As the flow rate through a drip filter or filter coffee machine of the prior art is determined largely by the resistance of the coffee bed and filter and it is known that this resistance increases as water flows through devices of the prior art it is also known that:
The first portion of beverage extracted through the coffee bed of devices of the prior art may be under-extracted, yielding a beverage that is weak, under developed and lacking flavour, due to a short extractable material/water contact time;
The intermediate portion of beverage extracted through the coffee bed of devices of the prior art may be optimally extracted;
The final portion of beverage extracted through the coffee bed of devices of the prior art may be over-extracted and bitter, due to a long extractable material/water contact time

The flow rate through known drip filter devices or filter machines is significantly slowed during extraction, and therefore the coffee bed and water contact time increased from too short to unacceptably too long to produce a beverage with optimal flavour characteristics.

It would be advantageous to provide a beverage preparation device of the drip filter type that enables the optimum beverage extract flow rate and coffee and water contact time for the preparation for a well extracted beverage. Such an optimum coffee and water contact time provides the conditions for a well-balanced coffee extract comprising the optimum combination of levels of fast and slow extracting coffee fractions.

It would also be advantageous to provide a beverage extraction device of the drip filter type that limits the difference in extractable material/water contact time between the first and last portion of beverage extracted. Similarly, it would be advantageous to provide a beverage extraction device that limits the difference in flow rate of coffee extract from a filter during the preparation of a beverage. Additionally, it would be advantageous to provide a beverage preparation device that delivers a flow of beverage extract with consistent level of extraction throughout the preparation of a beverage.

It is therefore an aim of embodiments of the invention to mitigate or reduce a disadvantage presented by the prior art.

### SUMMARY OF THE INVENTION

According to a first aspect of the invention there is provided a beverage extraction device comprising an upper chamber and a lower chamber separated by a filter; wherein the upper chamber comprises a perimeter wall and an inlet and the lower chamber comprises a perimeter wall and an outlet; and wherein the perimeter wall of the upper chamber adjacent to the filter tapers inwardly, towards the filter, by no more than 10 degrees, and the perimeter wall of the lower chamber tapers inwardly from adjacent to or proximal to the filter.

By “proximal” we mean generally within 8 mm of the filter, and so the tapering perimeter wall of the lower chamber may commence within 8 mm from the filter. Preferably the taper of the perimeter wall of the lower chamber commences within 7 mm, 6 mm or 5 mm, and in preferred embodiments commences within 4 mm, 3 mm, 2 mm or 1 mm, of the filter.

In some embodiments the perimeter wall of the upper chamber tapers by no more than 8°, 6°, 4°, 2° or no more than 1°. In preferred embodiments the perimeter wall of the upper chamber is non-tapering.

In some embodiments, the perimeter wall of the upper chamber is parallel-sided.

Parallel-sided, non-tapering perimeter walls of the upper chamber are particularly effective because they provide an extraction chamber geometry that allows for convection of the water/coffee solution; a sufficiently high fill height for a given volume of water (vs for example the funnel shape in a drip filter appliance) to further enhance the convection; a lower deposition of coffee grounds on the sides of the container (vs for example the funnel shape in a drip filter appliance); an even deposition of coffee grounds in the coffee bed upon draining the extraction chamber, facilitating even extraction; a small footprint; a smaller liquid surface to facilitate lower heat loss.

The upper chamber perimeter wall may be tubular and may have a circular, oval or polygonal cross-section, but is preferably circular. Embodiments in which the upper chamber perimeter wall has a circular cross-section and the wall is substantially entirely non-tapering are particularly useful for the achieving the benefits stated above.

In some embodiments the perimeter wall of the upper chamber may comprise an upper portion having an inward taper of no more than 10°, and a lower portion, adjacent to the filter, being non-tapering and parallel-sided. The upper portion may have an inward taper of no more than 8°, 6°, 4° or 2°. The upper portion may comprise no more than 50% of the total height of the perimeter wall of the upper chamber, preferably no more than 40%, 30%, 20% or 10%. Such embodiments may have an advantage of convenient filling with an extractable beverage into the upper, tapering portion of the upper chamber.

In some embodiments, the internal diameter of the perimeter wall of the upper chamber is between 30 mm and 100 mm, preferably between 40 mm and 80 mm, more preferably between 50 mm and 70 mm

In some embodiments, the perimeter wall of the upper chamber has a height, measured from the filter, of at least 50 mm, preferably between 50 mm and 200 mm.

In some embodiments, the volume of the upper chamber is between 100 and 500 ml, preferably between 200-400 ml, most preferably between 250-350 ml.

Embodiments with such dimensions have the additional advantage of providing the optimum dimensions for the preparation of 2 cups of beverage extract with the optimum extractable material/water contact time during extraction.

In some embodiments, the lower chamber of the beverage extraction device comprises an unobstructed fluid path from the filter to the outlet, preferably the filter and/or support are the only components of the device present between the inlet and the outlet, most preferably there is no structure within the space bounded by the filter and/or support and perimeter wall of the lower chamber. An unobstructed fluid path means that fluid is able to drain unobstructed from the outlet of the lower chamber without significantly affecting the coffee/water contact time in the upper chamber throughout the preparation of a beverage and especially that the there is no obstruction present in or near the outlet.

Such embodiments have the particular advantage of allowing fluid to flow through the beverage extraction device continually, in use, and enabling improved quality and consistency of extraction throughout.

In some embodiments, there is a support at the bottom of the upper chamber for extractable beverage material. In preferred embodiments this support is a porous mesh or screen located between the upper and lower chambers.

In some embodiments the support is adjacent to the filter. The support may be above or below the filter.

In some embodiments, the upper chamber comprises the support or porous mesh.

The support may be fixed to the upper chamber and/or inner chamber; or may be removably attached to the upper and lower chamber.

In some embodiments, the support comprises the filter, while in other embodiments the beverage extraction devices comprises a separate support and filter. Such embodiments have the additional advantage of allowing for extractable beverage material to be conveniently loaded into the upper chamber of the beverage extraction device.

In some embodiments, more than 50%, 60%, 70% or 75% of the filter and/or support is perpendicular to the non-tapering wall of the upper and/or lower chamber, while in other embodiments, substantially all of the filter and/or support is perpendicular to the non-tapering wall of the upper and/or lower chamber.

Such embodiments allow for an even distribution of fluid flow through the filter and/or support and, in use, a consistent, low resistance to fluid flow from the filter and/or support.

In some embodiments, the upper chamber is removably attached to the lower chamber. In preferred embodiments, the upper chamber is removably attached to the lower chamber such that the support (when present) and/or the filter are fixed to either the upper or lower chamber when the upper chamber and lower chamber are separated, in use.

Such embodiments have the additional advantage of convenient storage and washing of the components.

In some embodiments the filter is a separate component and may be disposable, interchangeable and/or washable. Such embodiments have the additional advantage of consistent flow resistance from the filter and easy cleaning.

In preferred embodiments the tapering perimeter wall of the lower chamber is adjacent to the filter and is preferably contiguous with, adjacent to and/or abutting the filter. In such embodiments the taper of the tapering perimeter wall may commence adjacent to the filter (or support). In other embodiments there may be a short length of non-tapering perimeter wall of the lower chamber, such that the tapering section of the perimeter wall commences no more than 8 mm below the filter (or support), preferably no more than 7 mm, 6 mm or no more than 5 mm from the filter (or support).

In some embodiments, the maximum diameter of the tapering perimeter wall or tapering section of the tapering perimeter wall of the lower chamber is no more than the diameter of the perimeter wall of the upper chamber adjacent to the filter. In preferred embodiments the maximum diameter of the tapering perimeter wall or tapering section of the lower chamber is at least 25%, 30% or, preferably 35% of the diameter of the perimeter wall of the upper chamber, adjacent to the filter; no more than 95%, 90%, 85% or, preferably 80% of the diameter of the perimeter wall of the upper chamber, adjacent to the filter; or between 25% and 95%; 30% and 90%; 35% and 85% or 35% and 80% of the diameter of the perimeter wall of the upper chamber, adjacent to the filter, and preferably between 35% and 90%.

In some embodiments, the tapering perimeter wall or tapering section of the lower chamber tapers inwardly at an angle of between 30 and 60 degrees (relative to the plane of the filter). In some embodiments, the tapering perimeter wall or tapering section of the lower chamber tapers at an angle of 45 degrees (relative to the plane of the filter).

Without being bound by any theory, it is believed that the use of a tapering lower chamber adjacent to or within 8 mm of the filter, has the effect of creating, in use, a meniscus of beverage extract below the filter and optimum flow resistance through the beverage extraction device for the optimum extractable material/water contact time.

In some embodiments, in use, the filter provides low resistance to the fluid flow through the beverage extraction device. Preferably, the filter provides less than 50%, 30% or 20% of the total flow resistance through the beverage extraction device.

In such embodiments, in use, the flow resistance through the beverage extraction device is substantially created by the geometry of the upper and lower chambers and remains consistent throughout the preparation of a beverage.

In embodiments of the first aspect of the invention, the lower chamber comprises an outlet. The outlet may comprise a non-tapering section of the perimeter wall of the lower chamber, extending from the distal end thereof. Thus the outlet may comprise a parallel-sided wall or walls. The outlet may be tubular, and may have a circular or oval cross section, for example. The diameter of the outlet of the lower chamber may be no more than 75% of the maximum diameter of the lower chamber, and may be between 25% and 75%, such as around 50% of the maximum diameter. In some embodiments, the outlet of the lower chamber has a diameter of between 10 mm and 20 mm, preferably between 13 mm and 17 mm.

In some embodiments, the beverage extraction device may be inserted into a beverage preparation apparatus, comprising a means of delivering heated water to the inlet of the upper chamber and a means of collecting beverage fluid from the lower chamber. In preferred embodiments the beverage preparation apparatus is a drip filter coffee appliance.

According to a second aspect of the invention, there is provided a method of preparing a beverage comprising, providing the beverage extraction device of a first aspect of the invention and comprising steps of:

a. Addition of an extractable beverage material to the upper chamber of the beverage extraction device;

b. Addition of water to the extractable beverage material in the upper chamber to create a beverage extract; and

c. Collection of the beverage extract from the lower chamber of the beverage extraction device.

In some embodiments, the water is heated water, and is preferably between 80-100° C. when it enters the upper chamber.

In some embodiments, the volume of water is between 100 and 500 ml, preferably between 200-400 ml, most preferably between 250-350 ml.

Such embodiments provide the optimum conditions for the preparation of 2 cups of beverage extract. In some embodiments, the water is added via the inlet and flows from the upper chamber to the lower chamber, exiting via the outlet as beverage extract.

In some embodiments, the mass of the extractable beverage material is between 10 g and 50 g.

In some embodiments, the extractable beverage material is roast and ground coffee and or tea.

In some embodiments, the ratio of the volume of water added to the upper chamber to the mass of extractable beverage material is between 10:1 and 2:1.

In some embodiments, the total extraction time, is less than 5 minutes, preferably less than 4 minutes, especially is between 2 minutes 30 seconds to 3 minutes 30 seconds.

By ‘total extraction time’ we mean the time measured from the moment water begins to be added to the upper chamber to the moment that beverage extract has substantially ceased to flow from the outlet of the lower chamber.

Such embodiments have the additional advantage of optimum extractable material/water contact time to produce an optimum beverage extract.

In some embodiments, the flow rate from the lower chamber is between 0.8 ml/sec-2 ml/sec, most preferably between 1 ml/sec-1.6 ml/sec.

In some embodiments, the flow rate from the lower chamber over 80% of the total extraction time is substantially constant, preferably between 1 ml/sec-1.6 ml/sec.

In some embodiments, the water is added to the upper chamber through the inlet at a substantially constant rate until the volume of water has been depleted.

In some embodiments, the rate of water addition via the inlet and the rate of beverage extract flow from the lower chamber reach a steady equilibrium state.

In some embodiments, the rate of water addition via the inlet is arranged to initially exceed the rate of beverage extract flow from the lower chamber, forming a filling phase.

In some embodiments, towards the end of the total extraction time, the flow of beverage extract from the outlet exceeds the rate of water addition via the inlet forming a draining phase.

In some embodiments, the duration of the steady equilibrium state is longer than the duration of the filling and/or the draining phase.

In some embodiments, the steady equilibrium state is between 25% and 75% of the total extraction time, preferably between 40 and 60% of the total extraction time.

In some embodiments, the duration of the steady equilibrium state is longer than the sum of the durations of the filling and draining phases and may therefore comprise greater than 50% of the total extraction time such as between 50% and 75% of the extraction time.

In such an equilibrium state the upper chamber experiences turbulence and convention flow, increasing the rate of extraction. Such embodiments have the particular advantages associated with such an equilibrium state and provide a further optimised beverage extract.

In embodiments where the total volume of water is between 250 ml-350 ml the steady equilibrium state may be between 30 seconds and 180 seconds, preferably between 60 seconds and 140 seconds.

Such embodiments have the additional advantage of further optimised extractable material/water contact time for the preparation of 2 average (125-175 ml) cups of beverage extract.

In some embodiments, the water is driven from inlet to lower chamber of the extraction device under atmospheric pressure, thus drainage of the extraction device is preferably solely under the force of gravity. Such embodiments have the additional advantage of reduced complexity in manufacturing, lower cost, easier cleaning and consumer preference.

According to a third aspect of the invention, there is provided a beverage preparation apparatus comprising the beverage extraction device of the first aspect of the invention; a water heating device; and a water conduit, and wherein, the water conduit is arranged in use to deliver water heated by the water heating device into the upper chamber of the beverage extraction device via the inlet.

In some embodiments, the beverage preparation apparatus is a drip filter coffee appliance.

A drip filter appliance is an appliance that contains a water source and water heater configured to deliver hot water above a bed of coffee or other beverage material. The hot water mixes with the beverage material and beverage extract drips through a filter and funnel into a container, usually a heated jug. An example of a known drip filter coffee appliance is the Excellent 10SN manufactured by Douwe Egberts.

Embodiments that make use of existing drip filter beverage appliances have the additional advantage of backwards compatibility and improvement to existing equipment.

In some embodiments, the water heating device is an electrical heating element.

In some embodiments, expansion of the heated water causes it to flow through the water conduit to the inlet.

In some embodiments, the apparatus further comprises a water storage tank operably connected to the water heating device and water conduit.

In some embodiments, the outlet of the water conduit is a spout or jet and/or a spray head.

In some embodiments, at least one of the upper chamber; filter; support and/or lower chamber are removably attached to the beverage extraction apparatus.

In some embodiments, the whole beverage extraction device is removably attached to the beverage extraction apparatus. Such embodiments have the additional advantage of ease of refilling with extractable beverage material and cleaning.

According to a fourth aspect of the invention, there is provided a method of preparing a beverage comprising, providing the beverage preparation apparatus of the third aspect of the invention further comprising steps of:

a. Addition of an extractable beverage material to the upper chamber of the beverage extraction device;

b. Delivering water heated by the water heating device to the upper chamber of the beverage extraction device through the water conduit to create a beverage extract; and

c. Collection of the beverage extract from the lower chamber of the beverage extraction device.

In some embodiments, the method further comprises at least partially filling the water storage tank prior to dispensing water via the inlet.

In some embodiments, the total extraction time, is less than 5 minutes, preferably less than 4 minutes, especially is between 2 minutes 30 seconds to 3 minutes 30 seconds.

Such embodiments have the additional advantage of optimum extractable material/water contact time to produce an optimum beverage extract.

Embodiments and associated advantages of any of the first, second and third aspect of the invention apply equally to a fourth aspect of the invention.

### DETAILED DESCRIPTION OF THE INVENTION

In order that the invention may be more clearly understood embodiments thereof will now be described, by way of example only, with reference to the accompanying drawings, of which:

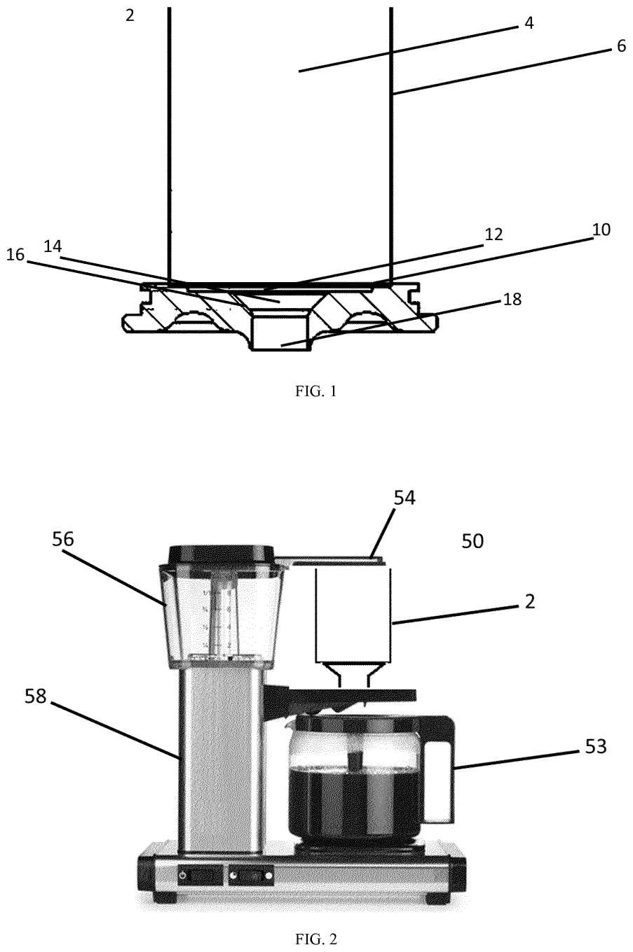

FIG. 1 is a side cross-sectional view through a first embodiment of a beverage preparation device of the invention;

FIG. 2 is a side view of a first embodiment of a beverage preparation apparatus of the invention;

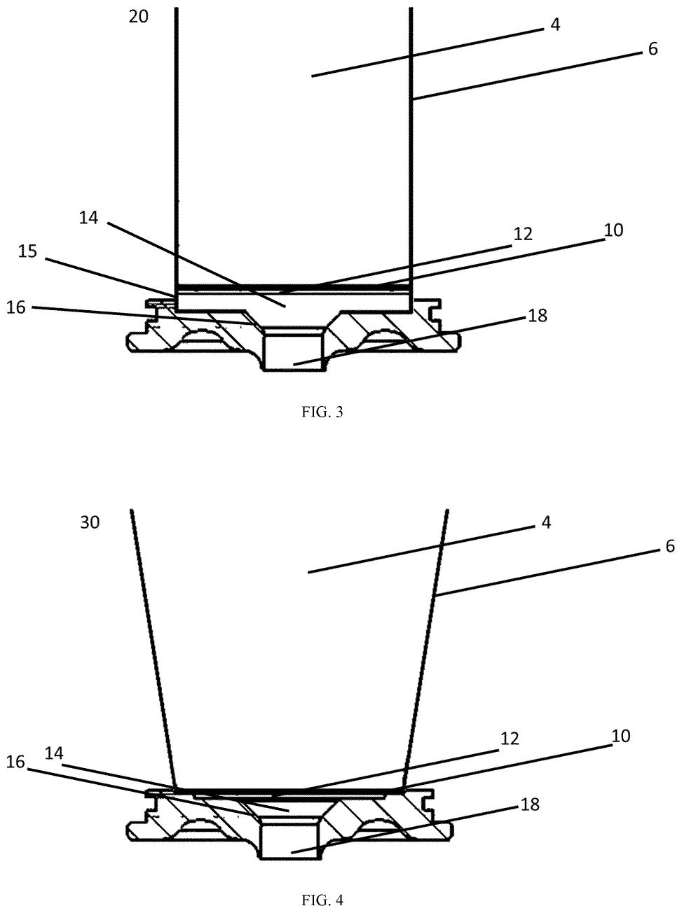

FIG. 3 is a side cross-sectional view through a second embodiment of a beverage preparation device of the invention comprising a lower chamber perimeter wall with non-tapering section; and

FIG. 4 is a side cross-sectional view through a third embodiment of a beverage preparation device of the invention comprising an upper chamber perimeter wall with a slight taper.

With reference to FIG. 1, a first embodiment of a beverage extraction device (2) of the invention, comprises an upper chamber (4) and a lower chamber (14) separated by a support in the form of a porous mesh screen (10) and a paper filter (12). The upper chamber (4) comprises a perimeter wall (6). The lower chamber comprises a perimeter wall (16) and an outlet (18).

The upper chamber perimeter wall (6) is non-tapering adjacent to the mesh screen (10). The mesh screen (10) is adjacent to and on top of the paper filter (12). In other embodiments, not shown, the vertical order of the mesh screen (10) and paper filter (12) may be reversed. The mesh screen (10) has a mesh size of 0.85 mm and thread diameter of 0.5 mm. The paper filter (12) has thickness of 1.1 mm, a low flow resistance and a diameter of less than the diameter of the upper chamber (4) (approximately 80-90% of the diameter of the upper chamber (4)). The lower chamber (14) is adjacent to the paper filter (12). The perimeter wall of the lower chamber (16) tapers down away from the paper filter (12) at an angle of 45° to a minimum diameter of 15 mm over a length of 6.1 mm to meet the outlet (18). The total length from the top of the filter paper (12) to the end of the outlet (18) is 17 mm. The lower chamber (14) has a volume of 6 ml and the upper chamber (4) a volume of 350 ml.

The tapering lower chamber wall (16) has a greatest diameter, adjacent to the filter (10) and mesh screen (12), of approximately 40% of the diameter of the upper chamber (4).

The outlet (18) comprises a circular cross-sectional tube, having a diameter approximately 60-70% of the largest diameter of the lower chamber wall (16).

With reference to FIG. 2, where like numbers represent like components vis-à-vis FIG. 1, a beverage preparation apparatus (50) comprises a beverage extraction device (2), a means for supplying water, in the form of a water tank (56), a beverage preparation apparatus body containing a water heater (58), a water outlet (54) and a beverage container (53). The water tank (56), the water heater (58) and the water outlet (54) are connected together by pipework (not shown). The water outlet (54) is located adjacent to the upper chamber of the beverage extraction device (2) and the beverage container is located below the outlet (18) of the beverage extraction device (2).

With reference to FIG. 3, where like numbers represent like components vis-à-vis FIG. 1, a beverage extraction device (20) comprises an upper chamber (4) and a lower chamber (14) separated by a support in the form of a mesh screen (10) and a paper filter (12). The upper chamber (4) comprises a perimeter wall (6). The lower chamber comprises an upper non-tapering perimeter wall section (15) adjacent to the filter (12) and mesh (10); a tapering lower perimeter wall section (16) and an outlet (18). The beverage extraction device is largely similar to the beverage extraction device (2) of FIG. 1; but differs by addition of the upper non-tapering perimeter wall section (15) of the lower chamber adjacent to the filter (12) and mesh screen (10) that acts to separate the tapering lower perimeter wall section (16) from the filter (12) by 5 mm; and the filter (12) extends across the full diameter of the upper chamber (4) and upper chamber perimeter wall (6).

With reference to FIG. 4, in which like numbers represent like components vis-à-vis FIG. 1, a beverage extraction device (30), comprises an upper chamber (4) and a lower chamber (14) separated by a support in the form of a mesh screen (10) and a paper filter (12). The upper chamber (4) comprises a perimeter wall (6). The lower chamber comprises a perimeter wall (16) and an outlet (18). The beverage extraction device is largely similar to the beverage extraction device (2) of FIG. 1; but differs by the perimeter wall of the upper chamber (6), having a taper of approximately 9° towards the filter (12).

### Example 1—Preparation of a Beverage Using a Beverage Extraction Device of the Invention

A beverage was prepared using the beverage extraction device (2) of FIG. 1 by the following steps:
a) The upper chamber (4) was loaded with 12 g of roast and ground coffee (Aroma Rood®, produced by Jacobs Douwe Egberts), the device (2) fitted with a Senseo® chocolate filter paper, code UPC05A and the device (2) supported above a beverage container;
b) 234 ml of water heated to 80-100° C. was then added at a rate of 2.6 ml/sec to the upper chamber at a steady rate over 1 minute 30 seconds. During this time the volume of water in the upper chamber (4) of the beverage extraction device (2) built to a maximum i.e. the flow rate of heated water into the beverage extraction device (2) was the same as the flow rate of the beverage extract from the outlet (18) of the beverage extraction device (2); and
c) After the addition of water stopped, the beverage extraction device (2) was then left to drain until the beverage extract stopped flowing from the outlet (18). Approximately 3 minutes 15 seconds after the start of water addition to the device.

The device (2) of the embodiment of FIG. 1 is configured such that, in use, the flow rate of beverage extract is between 1 ml/s and 1.6 ml/s throughout the extraction process. The flow rate of extract from the device was slower than the flow rate of water into the device.

The flow rate through the beverage extraction device (2) is largely determined by the combination of resistances between the filter (12), mesh (10) and geometry of the lower chamber (14). The major contributors to the overall flow resistance through the device (2) of Example 1 are:
From the upper chamber (4), the beverage extract undergoes a portion of horizontal flow through the filter (12) and mesh (10) in order to reach the smaller diameter lower chamber (14), maximising the resistance provided by the low resistance filter paper (12).
Upon traversing through the mesh (10) and filter paper (12) the beverage extract forms a meniscus under the mesh (10), held by surface tension and supported by the geometry of the shoulders provided by the tapering perimeter wall (or tapering section of the perimeter wall) of the lower chamber (16). This meniscus provides additional flow resistance below the upper chamber.
The outlet (18) is configured (with a non-tapering perimeter wall) to provide little or no resistance to the flow of beverage extract.

There is also a contribution to overall resistance from the coffee bed and a slow increase in resistance due to the clogging of filter pores by coffee particles during extraction, but this is a far lower proportion of the total resistance through the device than in devices of the prior art, such as in Example 2, below.

By configuring the majority of the flow resistance through the beverage extraction device (2) to be present below the coffee bed and top surface of the filter (12), the device (2) of Example 1 benefits from a consistent flow rate throughout the extraction rather than the steadily decreasing flow rate of the prior art, such as Example 2, where the flow rate through the extraction device (2) is largely determined by the compacting coffee bed and clogging top surface of the filter (12).

The configuration of the upper chamber (6) with a substantially parallel, non-tapering circumferential wall and the difference in flow rate into and out of the extraction device enabled the creation of convection and turbulence in the upper chamber of the extraction device such that the coffee particles formed at least a partial suspension in the water during the preparation of the beverage—enhancing the extraction of the slow extracting coffee fractions.

Further, the geometry of the upper chamber a sufficiently high fill height for a given volume of water, compared to Example 2 below, to further enhance the convection; a lower deposition of coffee grounds on the sides of the container, compared to Example 2 below; an even deposition of coffee grounds in the coffee bed upon draining the extraction chamber, facilitating even extraction; a small footprint; a smaller liquid surface to facilitate lower heat loss during the preparation of the beverage extract.

### Example 2 (Control)—Preparation of a Control Beverage Using a Drip Filter Appliance of the Prior Art

A control beverage was prepared using a prior art Excellent 10SN drip filter appliance (50) manufactured by Douwe Egberts. The drip filter appliance includes a brew basket in the form of a frusto-conical plastic chamber tapering to a narrow outlet. The brew basket is arranged in use to receive a 3-dimensional filter liner by the following steps:
a) A filter liner and 12 g of roast and ground coffee were added to the brew basket of the appliance;
b) Cold water was added to the water reservoir (58) of the appliance (50);
c) The appliance was switched on to provide a steady flow of 234 ml of hot water at a rate of 2.6 ml/sec over 1 minute 30 seconds to the brew basket of the appliance (50) and the beverage extract collected below.

### Comparison of the Results of Example 1 and Control Example 2

### Beverage Extract Flow Rate:

The beverage extract flow rate in Example 1 was 1.2 ml/sec over the 3 minute 15 second beverage preparation time and varied very little between the initial rate of 1.6 ml/sec and the final rate of 1 ml/sec. In contrast the beverage extract flow in control Example 2 slowed significantly during the extraction process as the main influencers of resistance through the device were hampered by compaction of the coffee bed and the pores of the filter paper were clogged with coffee particles.

### Beverage Extract Flavour Profiles:

The beverage extracts obtained in Example 1 and control Example 2 were put to a trained professional sensory panel for analysis of select flavour attributes and the results are shown in Table 1.

TABLE 1
Comparison of sensory attributes between beverages
produced in example 1 and control example 2

| Flavour attribute | Example 1 | Control Example 2 |
|---|---|---|
| Light Taste | 50 | 39 |
| Bitter Taste | 35 | 44 |
| Sweet Taste | 27 | 19 |
| Fresh Taste | 40 | 26 |
| Dry Mouthfeel | 23 | 33 |

The data shows that the flavour obtained in the extract of Example 1 shows improved Light Taste, Sweet Taste, Fresh Taste and reduced Bitter Taste and Dry Mouthfeel over the beverage extract produced in the control Example 2. This sensory data supports the conclusion that there is an optimum extractable material/water contact time to be reached in such beverage extraction devices and that the extractable material/water contact time enabled by the beverage extraction devices (2) of the present invention yields an improved beverage over those produced by prior art devices.

The sensory evaluation confirmed an optimised balance of extraction between fast and slow extracting fractions of coffee compared in Example 1 compared to Example 2.

### Further Examples of Embodiments of the Invention

### Example 3: A Beverage Extract Prepared by a Beverage Preparation Apparatus of the Invention

A beverage extract was prepared by loading the beverage extraction device (2) of FIG. 1 into an Excellent 10SN drip filter appliance (50) manufactured by Douwe Egberts to create the beverage preparation apparatus (50) of FIG. 2 by the following steps:
a) 12 g of roast and ground coffee was added to the upper chamber (6) of the beverage extraction device (2);
b) Cold water was added to the water reservoir (58) of the appliance (50);
c) The appliance (50) was switched on to provide a steady flow of 234 ml of hot water at a rate of 2.6 ml/sec over 1 minute 30 seconds to the extraction device (2) attached to the appliance (50) and the beverage extract collected from the outlet (18) of the lower chamber (14) of the beverage extraction device (2).

The beverage extract flow rate was identical to that of Example 1 and the beverage had the same profile under sensory analysis as that of Example 1.

Alternative of Beverage Extraction Devices of the Invention

With reference to FIG. 1, when in use, the beverage extraction device (2) provides a fluid flow path for the beverage extract from upper chamber (4) to lower chamber (12). The route of the fluid flow path from upper chamber (4) to outlet (18), the filter paper (12) and/or mesh (10) properties and the meniscus size and shape formed below the filter (12) and mesh (10) have an impact on the flow resistance and therefore extractable material/water contact time and quality of the extracted beverage. The meniscus size and shape can be adjusted by variation in the maximum diameter of lower chamber perimeter wall (16). The tapering perimeter wall (16) of the lower chamber (14) of device (2) of FIG. 1 has the preferred maximum diameter of 40-50% the diameter of the perimeter wall of the upper chamber (6) whereas, embodiments of a device of the invention (not shown) exist that benefit from at least one of the advantages of FIG. 1 where the maximum diameter of the tapering perimeter wall (16) of the lower chamber of the device (2) of FIG. 1 is between one quarter to three quarters the diameter of the perimeter wall of the upper chamber (6). Further, the meniscus size and shape can be adjusted by variation in the angle of the taper of the perimeter wall of the lower chamber (16). In further embodiments of a beverage extraction device (2) of the invention (not shown) the taper of the perimeter wall of the lower chamber (16) of FIGS. 1-4 may be between 35° and 55°, for example, and maintain at least one of the benefits of the invention.

FIGS. 3 and 4 show examples of alternative beverage extraction devices (20) and (30). Each exhibits sufficient flow resistance below the coffee bed and top surface of the filter to secure the benefits associated with the beverage extraction device (2) of Example 1.

Further to variations of FIG. 1, the meniscus formation below the filter (12) and its impact on flow resistance through the device can also be manipulated by spacing the tapered perimeter wall of the lower chamber (16) away from the filter. With reference to FIG. 3, the short upper non-tapering perimeter wall section (15) of the lower chamber (14) provides additional volume to the lower chamber (16) without significantly hindering the formation of the coffee extract meniscus below the filter (12) and the resistance to flow through the device (20) this provides when in use. The lower non-tapering perimeter wall section (15) of the lower chamber (16) is spaced 5 mm from the filter (12).

With reference to FIG. 4, the small taper in the perimeter wall (6) of the upper chamber (6) provides an increase in volume to the upper chamber (6) and a larger opening at the top of the perimeter wall (6) for ease of adding beverage material into the upper chamber (4). No negative impact was seen to the benefits associated with the device of FIG. 1 by the inclusion of a small taper to the circumferential wall of the upper chamber. A turbulent, convection of the coffee/water suspension was still created, there was little deposition of coffee grounds on the circumferential wall, the coffee bed was deposited evenly across the filter and the heat loss from the upper chamber was largely unaffected.

The above embodiments are described by way of example only. Many variations are possible without departing from the scope of the invention as defined in the appended claims.

1. A beverage extraction device comprising an upper chamber and a lower chamber separated by a filter; wherein the upper chamber comprises a perimeter wall and an inlet and the lower chamber comprises a perimeter wall and an outlet; and wherein the perimeter wall of the upper chamber adjacent to the filter tapers inwardly, towards the filter, by no more than 10 degrees and the perimeter wall of the lower chamber tapers inwardly from adjacent to or proximal to the filter.

2. The beverage extraction device of claim 1 wherein the maximum diameter of the tapering perimeter wall adjacent to the filter or the tapering section of the lower chamber proximal to the filter is between 25% and 95% the diameter of the perimeter wall of the upper chamber adjacent to the filter.

3. The beverage extraction device of claim 1 wherein the lower chamber tapers inwardly from proximal to the filter and wherein there is a short length of non-tapering perimeter wall of the lower chamber, such that the tapering section of the perimeter wall commences no more than 8 mm below the filter.

4. The beverage extraction device of claim 1 wherein the lower chamber of the beverage extraction device comprises an unobstructed fluid path from the filter to the outlet.

5. The beverage extraction device of claim 1 wherein the volume of the upper chamber is no more than 500 ml.

6. The beverage extraction device of claim 1 wherein the perimeter wall of the upper chamber is non-tapering.

7. The beverage extraction device of claim 1 wherein the perimeter wall of the lower chamber tapers inwardly from adjacent to the filter.

8. A method of preparing a beverage comprising, providing the beverage extraction device of claim 1 and comprising steps of:
a. addition of an extractable beverage material to the upper chamber of the beverage extraction device;
b. addition of water to the extractable beverage material in the upper chamber to create a beverage extract; and
c. collection of the beverage extract from the lower chamber of the beverage extraction device.

9. The method of claim 8 wherein the volume of water added in step b) is between 100 and 400 ml.

10. The method of claim 9 wherein the water is added at a rate of at least 1 ml/sec.

11. The method of claim 8 wherein the total extraction time is between 2 and 5 minutes.

12. A beverage preparation apparatus comprising: the beverage extraction device of claim 1; a water heating device; and a water conduit, and wherein the water conduit is arranged, in use, to deliver water heated by the water heating device into the upper chamber of the beverage extraction device via the inlet.

13. The apparatus of claim 12 wherein the apparatus is a drip filter appliance.

14. A method of preparing a beverage comprising, using the beverage preparation apparatus of claim 12 and comprising steps of:
a. Addition of an extractable beverage material to the upper chamber of the beverage extraction device;
b. Delivering water heated by the water heating device through the water conduit and to the upper chamber of the beverage extraction device to create a beverage extract; and
c. Collection of the beverage extract from the lower chamber of the beverage extraction device.

15. The method of claim 14 wherein the total extraction time is between 2 and 5 minutes.
